(19) United States
(12) Patent Application Publication
(10) Pub. No.: US 2025/0370755 A1
(43) Pub. Date: Dec. 4, 2025

(54) PHYSICAL REGISTER DEALLOCATION IN A PROCESSING SYSTEM

(71) Applicant: International Business Machines Corporation, Armonk, NY (US)

(72) Inventors: Irwin Frimpong, Poughkeepsie, NY (US); Jonathan Ting Hsieh, Poughkeepsie, NY (US)

(21) Appl. No.: 18/680,032

(22) Filed: May 31, 2024

(51) Int. Cl. G06F 9/38; G06F 9/30

(52) U.S. Cl. CPC G06F 9/384; G06F 9/3863

(57) ABSTRACT

A processor includes a mapper circuit that, based on receiving an instruction group of multiple instructions for dispatch, establishes, in a first mapper structure, mappings of logical registers targeted by the multiple instructions to physical registers in the processor. The mapper circuit maintains, in a second mapper structure, prior mappings for the logical registers. The mapper circuit records, in a third mapper structure, physical registers previously allocated to the logical registers targeted by the instructions, where the third mapper structure has a lower access latency than the second mapper structure. Based on a flush event for the instruction group, the mapper circuit restores the prior mappings from the second mapper structure to the first mapper structure. Based on a complete event for the instruction group, the mapper circuit deallocates the physical registers previously allocated to the logical registers targeted by the instructions by reference to the third mapper structure rather than the second mapper structure.

### BACKGROUND OF THE INVENTION

The present invention relates in general to data processing, and more particularly, to accelerated physical register deallocation in a processing system.

A conventional processor may include an instruction dispatch unit for fetching instructions for execution, an instruction sequencing unit for ordering instructions for execution, and one or more execution units for executing the instructions. A conventional processor may additionally include a set of physical registers for storing operands accessed or produced in the course of execution of the instructions. In some processor architectures, the physical registers are referenced utilizing logical register identifiers, which are temporarily mapped to various ones of the physical registers by mapping logic within the processor. Logical-to-physical register mappings are typically maintained in entries in one or more mapping structures. The physical registers, logical registers, and entries in the mapping structures are all limited resources of the processor, the availability of which can impact instruction throughput and thus processor performance.

### SUMMARY OF THE INVENTION

In view of the foregoing, the present application appreciates that it would be advantageous and desirable to accelerate the deallocation of resources, such as physical registers, employed in the execution of instructions. Accelerating the deallocation of physical registers can, among other things, promote increased processor throughput and thus improved processor performance.

In at least one embodiment, a processor includes a mapper circuit that, based on receiving an instruction group of multiple instructions for dispatch, establishes, in a first mapper structure, mappings of logical registers targeted by the multiple instructions to physical registers in the processor. The mapper circuit maintains, in a second mapper structure, prior mappings for the logical registers. The mapper circuit records, in a third mapper structure, physical registers previously allocated to the logical registers targeted by the instructions, where the third mapper structure has a lower access latency than the second mapper structure. Based on a flush event for the instruction group, the mapper circuit restores the prior mappings from the second mapper structure to the first mapper structure. Based on a complete event for the instruction group, the mapper circuit deallocates the physical registers previously allocated to the logical registers targeted by the instructions by reference to the third mapper structure rather than the second mapper structure.

### BRIEF DESCRIPTION OF THE DRAWINGS

FIG. 1 is a high-level block diagram of an exemplary data processing system including a processor in accordance with one embodiment;

FIG. 2 is a high-level block diagram of an exemplary processor core in accordance with one embodiment;

FIG. 3 is a high-level block diagram of an exemplary mapper circuit in accordance with one embodiment;

FIG. 4 is a high-level block diagram of an exemplary set of physical registers that can be allocated and deallocated for instruction execution in accordance with one embodiment;

FIG. 5 is a high-level block diagram of an exemplary mapper history buffer for tracking the mapping of logical registers to physical registers in accordance with one embodiment;

FIG. 6 is a high-level block diagram of an exemplary global completion table (GCT) in accordance with one embodiment;

FIG. 7 is a high-level block diagram of an exemplary instruction group and corresponding MHB buffer entry and GCT entry in accordance with one embodiment;

FIG. 8 is a data flow diagram illustrating a process for deallocating a physical register in a mapper circuit of a processor core in accordance with the prior art;

FIG. 9 is a high-level logical diagram of an exemplary process by which a mapper circuit of an exemplary processor core establishes logical-to-physical register mappings in accordance with one embodiment;

FIG. 10 is a high-level logical diagram of an exemplary process by which a mapper circuit of an exemplary processor core accelerates deallocation of physical registers for instruction groups not subject to write-after-write (WAW) data dependencies in accordance with one embodiment;

FIG. 11 is a data flow diagram illustrating an exemplary process for accelerated deallocation of a physical register in a mapper circuit of a processor core in accordance with one embodiment; and

FIG. 12 is a design flow in accordance with at least one embodiment.

In accordance with common practice, various features illustrated in the drawings may not be drawn to scale. Accordingly, dimensions of the various features may be arbitrarily expanded or reduced for clarity. In addition, some of the drawings may not depict all of the components of a given system, method, or device. Finally, like reference numerals may be used to denote like or corresponding features in the specification and figures.

### DETAILED DESCRIPTION OF ILLUSTRATIVE EMBODIMENT

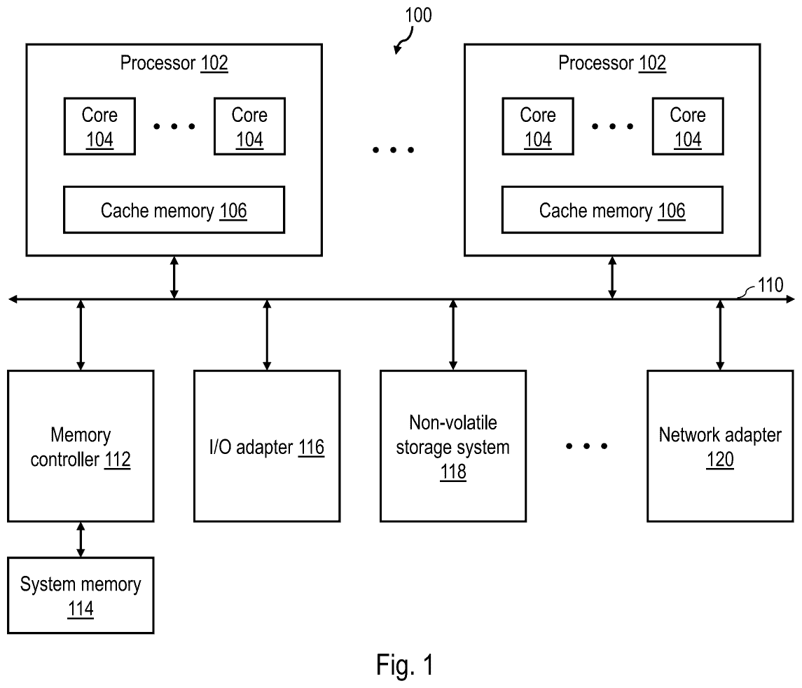

With reference now to the figures and in particular with reference to FIG. 1, there is illustrated a high-level block diagram of an exemplary data processing system 100 in accordance with one embodiment. In some implementations, data processing system 100 can be, for example, a mainframe computer system, a server computer system, a laptop or desktop personal computer system, a mobile computing device (such as a smartphone or tablet), or an embedded processor system.

As shown, data processing system 100 includes one or more processors 102 for processing instructions and data. Each processor 102 may be realized as a respective integrated circuit having a semiconductor substrate in which integrated circuitry is formed, as is known in the art. In at least some embodiments, processors 102 can generally implement any one of a number of commercially available processor architectures, for example, z/Architecture, POWER, ARM, Intel x86, NVidia, Apple silicon, etc. In the depicted example, each processor 102 includes one or more processor cores 104 for executing one or more simultaneous threads of execution and cache memory 106 providing processor cores 104 low latency access to instructions and operands likely to be read and/or written. Processors 102 are coupled for communication by a system interconnect 110, which in various implementations may include one or more buses, switches, bridges, and/or hybrid interconnects.

Data processing system 100 may additionally include a number of other components coupled to system interconnect 110. These components can include, for example, a memory controller 112 that controls access by processors 102 and other components of data processing system 100 to a system memory 114. In addition, data processing system 100 may include an input/output (I/O) adapter 116 for coupling one or I/O devices to system interconnect 110, a non-volatile storage system 118, and a network adapter 120 for coupling data processing system 100 to a communication network (e.g., a wired or wireless local area network and/or the Internet).

Those skilled in the art will additionally appreciate that data processing system 100 shown in FIG. 1 can include many additional non-illustrated components. Because such additional components are not necessary for an understanding of the described embodiments, they are not illustrated in FIG. 1 or discussed further herein. It should also be understood, however, that the enhancements described herein are applicable to data processing systems and processors of diverse architectures and are in no way limited to the generalized data processing system architecture illustrated in FIG. 1.

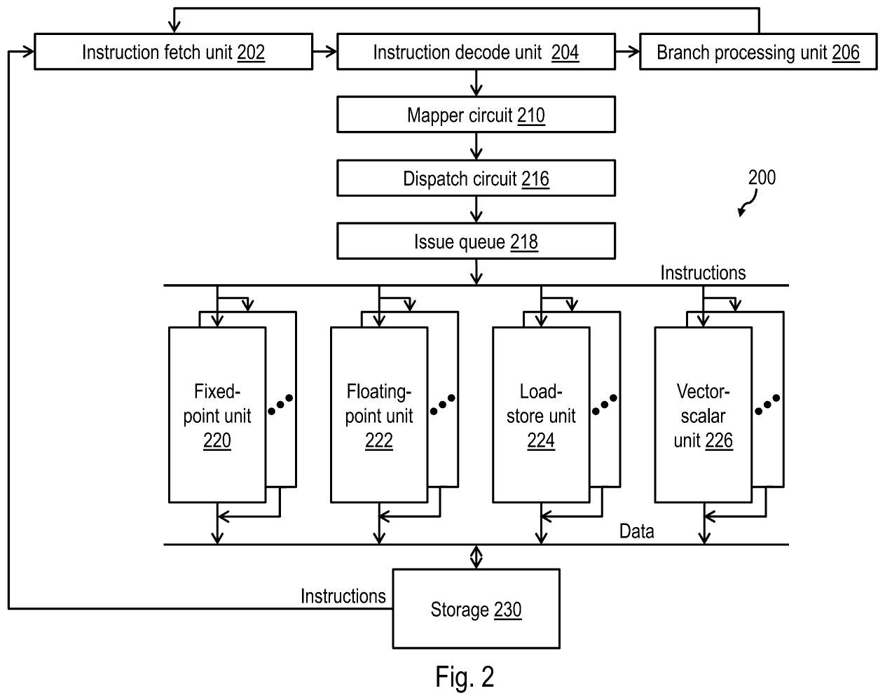

Referring now to FIG. 2, there is depicted a high-level block diagram of an exemplary processor core 200 in accordance with one embodiment. Processor core 200 may be utilized to implement any of processor cores 104 of FIG. 1.

In the depicted example, processor core 200 includes an instruction fetch unit 202 for fetching architected instructions within one or more threads of execution from storage 230 (which may include, for example, cache memories 106 and/or system memory 114 from FIG. 1). In a typical implementation, each architected instruction has a format defined by the instruction set architecture of processor core 200 and includes at least an operation code (opcode) field specifying an operation (e.g., fixed-point or floating-point arithmetic operation, vector operation, matrix operation, logical operation, branch operation, memory access operation, cryptographic operation, etc.) to be performed by processor core 200. Certain architected instructions may additionally include one or more operand fields directly specifying operands or implicitly or explicitly referencing one or more source registers storing source operand(s) to be utilized in the execution of the instruction and one or more target registers for storing destination operand(s) generated by execution of the architected instruction. Instruction decode unit 204, which in some embodiments may be merged with instruction fetch unit 202, decodes the architected instructions retrieved from storage 230 by instruction fetch unit 202 and forwards branch instructions that control the flow of execution to branch processing unit 206. In some embodiments, the processing of branch instructions performed by branch processing unit 206 may include speculating the outcome of conditional branch instructions. The results of branch processing (both speculative and non-speculative) by branch processing unit 206 may, in turn, be utilized to redirect one or more streams of instruction fetching by instruction fetch unit 202.

Those skilled in the art will appreciate that in certain processor architectures, individual architected instructions can be “cracked” or converted into multiple distinctly executable microcode operations (sometimes referred to as “micro ops”). Such instruction cracking may be performed by instruction decode unit 204 or elsewhere in the instruction pipeline(s). Because the distinction between microcode operations and architected instructions is not relevant to the described embodiments, the generic term “instruction” is utilized hereafter to refer to architected instructions and/or internal microcode operations.

Instruction decode unit 204 forwards instructions that are not branch instructions (often referred to as “sequential instructions”) to mapper circuit 210. Mapper circuit 210 is responsible for the assignment of physical registers within the register files of processor core 200 to instructions as needed to support instruction execution. Mapper circuit 210 preferably implements register renaming. Thus, for at least some classes of instructions, mapper circuit 210 establishes transient mappings between a set of logical (or architected) registers referenced by the instructions and a larger set of physical registers within the register files of processor core 200. As a result, processor core 200 can avoid unnecessary serialization of instructions that are not data dependent, as might otherwise occur due to the reuse of the limited set of architected registers by instructions proximate in program order.

Still referring to FIG. 2, processor core 200 additionally includes a dispatch circuit 216 configured to ensure that any data dependencies (e.g., RAW (Read after Write), WAR (Write after Read), or WAW (Write after Write)) between instructions are observed and to dispatch sequential instructions as they become ready for execution. Instructions dispatched by dispatch circuit 216 are temporarily buffered in an issue queue 218 until the execution units of processor core 200 have resources available to execute the dispatched instructions. As the appropriate execution resources become available, a control circuit within issue queue 218 issues instructions from issue queue 218 to the execution units of processor core 200 opportunistically and possibly out-of-order with respect to the original program order of the instructions.

In the depicted example, processor core 200 includes several different types of execution units for executing respective different classes of instructions. In this example, the execution units include one or more fixed-point units 220 for executing instructions that access fixed-point operands, one or more floating-point units 222 for executing instructions that access floating-point operands, one or more load-store units 224 for loading data from and storing data to storage 230, and one or more vector-scalar units 226 for executing instructions that access vector and/or scalar operands. In a typical embodiment, each execution unit is implemented as a multi-stage pipeline in which multiple instructions can be simultaneously processed at different stages of execution. Each execution unit preferably includes or is coupled to access at least one register file including a plurality of physical registers for temporarily buffering operands accessed in or generated by instruction execution.

Those skilled in the art will appreciate that processor core 200 may include additional unillustrated components and/or circuits. Because these additional components and/or circuits are not necessary for an understanding of the described embodiments, they are not illustrated in FIG. 2 or discussed further herein.

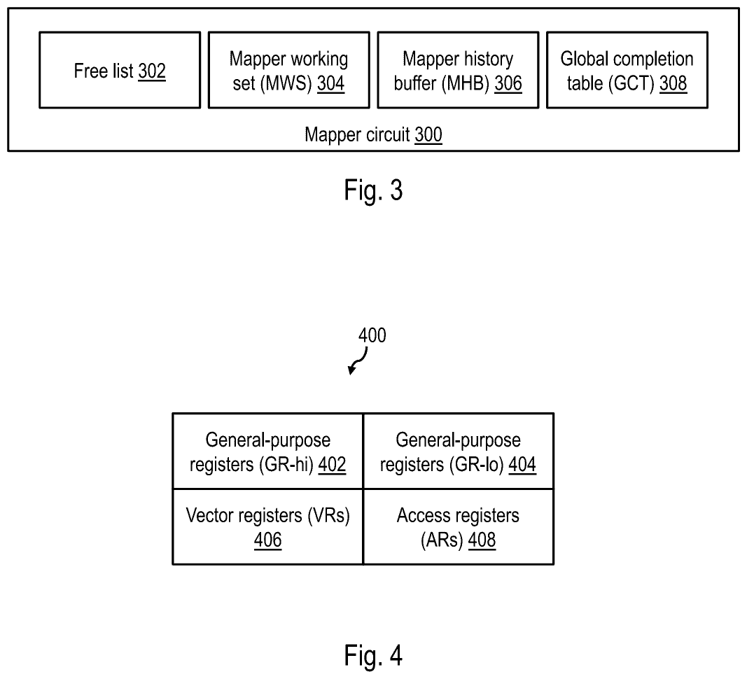

With reference now to FIG. 3, there is illustrated a more detailed block diagram of a mapper circuit 300 in accordance with one embodiment. Mapper circuit 300 is one example of a circuit that can be utilized to implement mapper circuit 210 of FIG. 2.

Mapper circuit 300 includes and/or is communicatively coupled to a number of different structures maintained by mapper circuit 300 to track the allocation and deallocation of processor resources and the progress of instruction execution. In the illustrated example, mapper circuit 300 includes a free list 302, which mapper circuit 330 uses to track which physical registers within processor core 200 are deallocated (and thus free for allocation to buffer instruction operands) and which physical registers are allocated to buffer instruction operands. Examples of types of physical registers within processor core 200 are described below with reference to FIG. 4. In at least some implementations, the physical registers may be uniquely identified and tracked by register tags (RTAGs).

The resource tracking structures of mapper circuit 300 shown in FIG. 3 additionally include a mapper working set (MWS) 304, which is utilized by mapper circuit 300 to track a current state of mapping of architected logical registers (LREGs) referenced by instructions and the physical registers (e.g., RTAGs) of processor core 200. Mapper circuit 300 may additionally have a mapper history buffer (MHB) 306 for tracking logical-to-physical register mapping history to enable restoration of the MWS 304 to a prior state in the event that one or more instructions undergoing execution are flushed (e.g., due to branch misprediction). Mapper circuit 300 can additionally include a global completion table (GCT) 308 for tracking completion of instruction groups and assisting in the tracking of physical register allocation/deallocation.

Referring now to FIG. 4, there is depicted a high-level block diagram of exemplary physical registers 400 of a processor core that can be allocated to buffer instruction operands in accordance with one embodiment. As noted above, physical registers files can be disposed within and/or communicatively coupled to one or more of execution units 220-226. In this example, physical registers 400 include at least four physical register files, including vector registers (VR) 406, access registers (AR) 408, and two general-purpose register (GRs) files 402, 404. In this example, one GR file (e.g., GR-hi 402) contains physical registers for storing the high half of long word operands, and another GR file (e.g., GR-lo 404) contains a corresponding number of physical registers for storing the low half of long word operands. Thus, for example, if a long word operand is 64 bits in length, an upper half of the long word (e.g., bits 0:31) can be buffered in a physical register in GR-hi 402, and the lower half of the long word operand (e.g., bits 32:63) can be buffered in the corresponding physical register in GR-lo 404. Of course, the physical registers of GR files 402, 404 can additionally be utilized to store individual short word operands as well. Those skilled in the art will appreciate that, in various embodiments, physical registers 400 can include a greater or fewer number of physical register files and/or different types of physical register files.

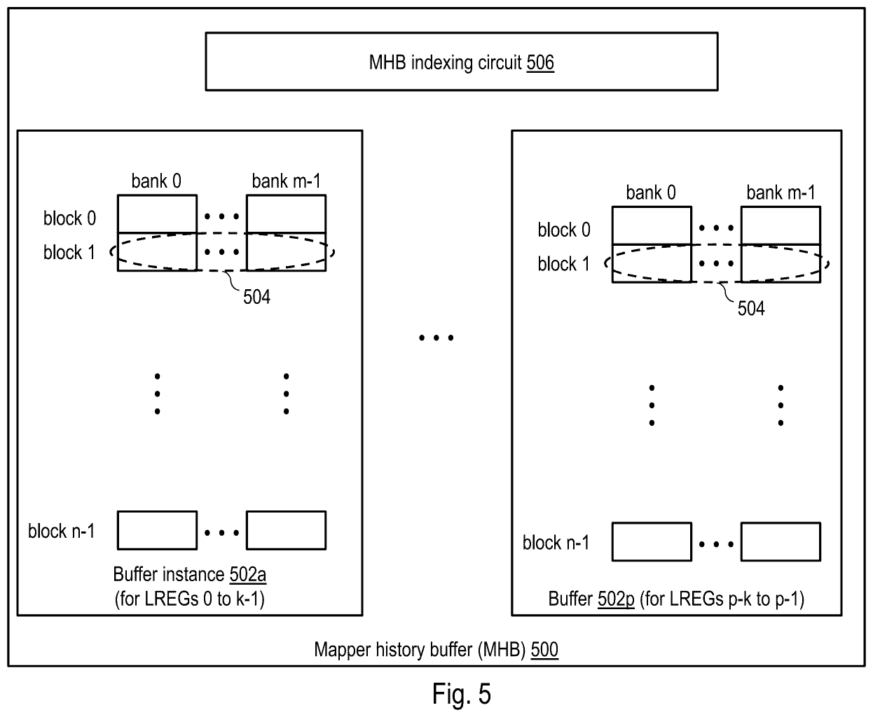

With reference now to FIG. 5, there is illustrated a high-level block diagram of an exemplary mapper history buffer (MHB) 500 for tracking the historical mappings of logical registers to physical registers in accordance with one embodiment. MHB 500, which is one example of a MHB 306 as illustrated in FIG. 3, can include one or more buffer instances 502 for temporarily buffering prior logical-to-physical register mappings evicted from MWS 304. In this example, the buffer storage of MHB 500 is partitioned into a plurality of buffer instances 502a-502p, each of which provides buffer storage for prior logical-to-physical register mappings for a respective subset of LREGs. For example, in FIG. 5, the architected LREGs are partitioned into P equal subsets of K LREGs (P and K being positive integers), and each of buffer instances 502a-502p buffers prior register mappings for a respective one of the P subsets.

FIG. 5 further illustrates that the storage in each buffer instance 502 can be structured as N blocks each containing M banks (M and N being positive integers), for example, to allow efficient buffer management that supports age ordering with respect to instruction dispatch, thread sharing, and a desired register file implementation. Each block of buffer storage in a buffer instance 502 is referred to herein as a MHB entry 504. In a partitioned embodiment such as that depicted in FIG. 5, MHB 500 additionally includes a MHB indexing circuit 506 that facilitates access to the entries 504 storing the mappings for specified LREGs. For example, MHB indexing circuit 506 may utilize the most significant bit(s) of a LREG to select one of buffer instances 502a-502p for storing a prior mapping of a specified LREG and may utilize additional information (e.g., thread ID, instruction group ID, etc.) to select MHB entries 504 within the buffer instances 502. Each MHB entry 504 may store, for a given LREG, an evicted mapping (a prior logical-to-physical register mapping before a dispatched instruction remapped the LREG) as well as a target mapping (a new mapping for the dispatched instruction that targets a write to the LREG). The mapping contained in a MHB entry 504 may be deallocated from MHB 500 upon completion of the corresponding dispatched instruction, or, in the event of a flush event affecting the dispatched instruction, may be restored to MWS 304.

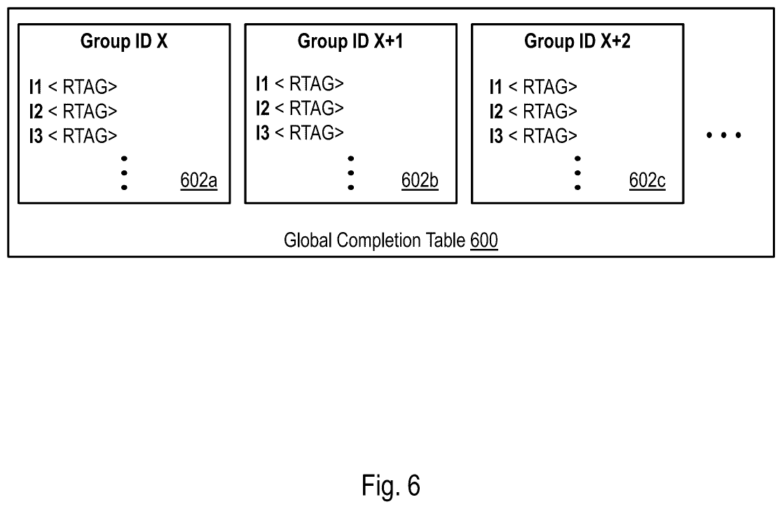

Referring now to FIG. 6, there is depicted a high-level block diagram of an exemplary global completion table (GCT) 600 in accordance with one embodiment. GCT 600 is one example of a structure that can be utilized to implement GCT 308 of FIG. 3.

In the illustrated example, GCT 600 includes a plurality of GCT entries 602 (i.e., 602a, 602b, 602c, . . . ), each respectively corresponding to a dispatched and uncompleted instruction group. For example, GCT entry 602a corresponds to an instruction group assigned Group ID X, where X is a positive integer. In addition to possibly additional information related to completion conditions for the associated instruction group, each GCT entry 602 preferably specifies the prior (evicted) RTAG, if any, associated with the LREG written by each instruction in the instruction group.

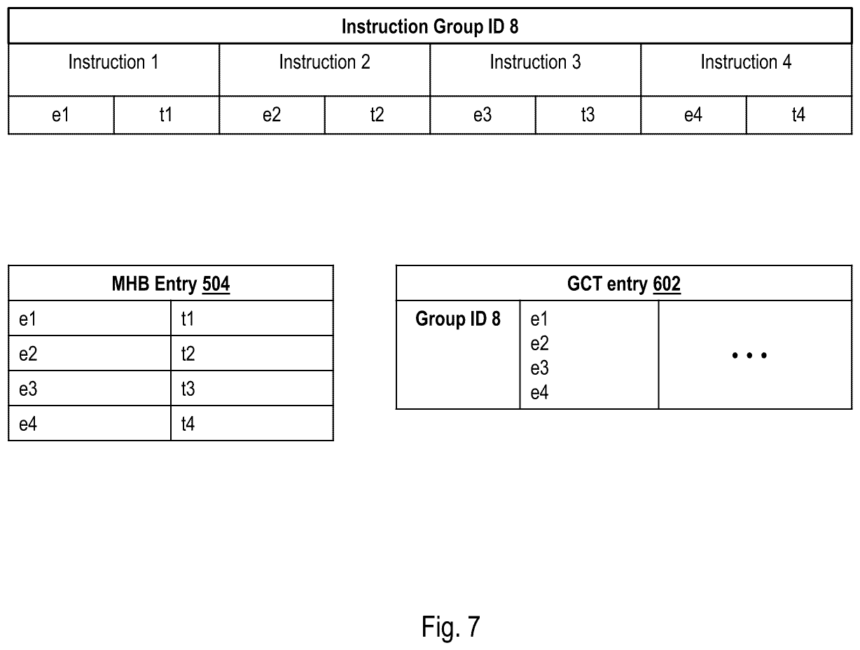

FIG. 7 is a high-level block diagram of an exemplary instruction group and a corresponding MHB entry and global completion table entry in accordance with one embodiment. In this example, an instruction group assigned Group ID 8 includes four instructions, namely, instructions 1 to 4. Associated with each of these instructions is a respective evicted (old) RTAG (e.g., e1, e2, e3, or e4, respectively) associated with the target LREG written by the instruction prior to dispatch of the instruction and a target (new) RTAG (e.g., t1, t2, t3, or t4, respectively) currently associated with the LREG written by the instruction. Based on this instruction group, mapper circuit 300 stores within MHB 500 an MHB entry 504 specifying at least the target RTAG of each of the instructions within the instruction group assigned Group ID 8. In addition, mapper circuit 300 stores within GCT 600 a GCT entry 602 specifying for Group ID 8 the evicted (old) RTAGs of the instructions in instruction group 8. As explained below, tracking evicted RTAGs in GCT 600 enables mapper circuit 300 to accelerate the deallocation of RTAGs in free list 302.

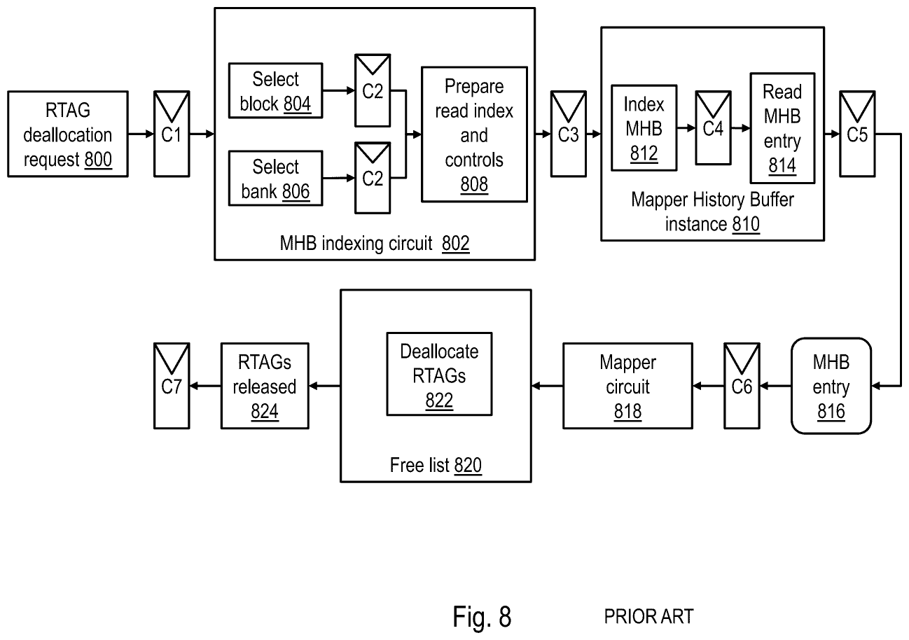

Referring now to FIG. 8 is a data flow diagram illustrating a process for deallocating a physical register (i.e., a RTAG) in a mapper circuit of a processor core in accordance with a prior art implementation in which evicted RTAGs are not buffered in a GCT (as described above with reference to FIG. 7), but are instead buffered in a partitioned mapper history buffer (MHB) similar to that illustrated in FIG. 5. In this data flow, processor cycles elapsed in the deallocation process are represented by latches distributed in the data flow path, where the names of the illustrated latches designate the number of elapsed cycles (C1, C2, etc.).

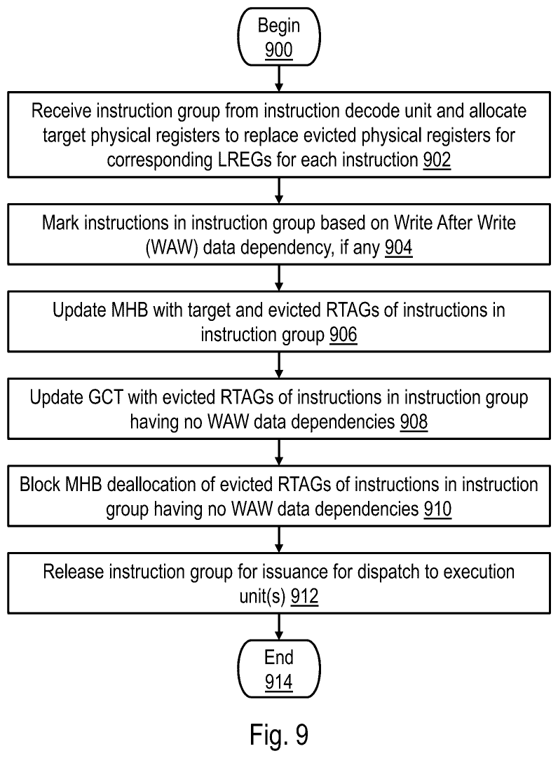

In this example, a RTAG deallocation request 800 requesting deallocation of one or more RTAGs is latched at a first cycle. RTAG deallocation request 800 may specify, for example, a thread ID, instruction group ID, LREG, and/or evicted RTAG. Based on the contents of RTAG deallocation request 800, a MHB indexing circuit 802 may select a relevant block and bank of a MHB entry, as depicted at blocks 804 and 806, respectively. The block and bank selections are latched at the end of cycle 2. MHB indexing circuit 802 additionally prepares the correct read index and control signals to access the MHB entry buffering the mapping for the evicted RTAG. The read index and control signals are latched at the end of cycle 3. In processor cycles 4-5, a particular MHB buffer instance in the partitioned MHB is selected as shown at block 812, and the relevant portion of the MHB entry 816 is read utilizing the selected block and bank. The MHB entry 816 output from the MHB instance 810 is latched at the end of cycle 6. During cycle 7, mapper circuit 818 deallocates in free list 820 the RTAGs specified in MHB entry 816, as shown at block 822. The deallocation of the RTAGs in free list 820 releases the deallocated RTAGs for subsequent reallocation, as shown at block 824. The present application appreciates that the prior art process of FIG. 7 can be significantly accelerated in cases in which the instruction group does not contain any WAW data dependencies, as is now described with reference to FIGS. 9-11.

With reference now to FIG. 9, there is illustrated is a high-level logical diagram of an exemplary process by which a mapper circuit 300 of an exemplary processor core 200 records logical-to-physical register mappings in accordance with one embodiment. The process of FIG. 9 can be performed by mapper circuit 300 for each instruction group executed in the processor core 200, and multiple instances of the process can be performed concurrently.

The process begins at block 900 and then proceeds to block 902, which illustrates mapper circuit 300 receiving an instruction group from instruction decode unit 204 and allocating currently unallocated target RTAGs from free list 302 to the target LREGs of the instructions in the instruction group. The RTAGs previously mapped to the target LREGs form a set of evicted RTAGs. At block 904, mapper circuit 300 marks instructions in the instruction group based on whether the instructions have a WAW data dependency on (i.e., write to the same LREG as) another instruction in the instruction group. In various implementations, the marking depicted at block 904 can be performed, for example, by mapper circuit 300 setting (or resetting) a respective bit in GCT 600 for each instruction in the instruction group not having a WAW dependency on another instruction in the instruction group or by setting (or resetting) a respective bit in GCT 600 for each instruction in the instruction group having a WAW dependency on another instruction in the instruction group. This marking designates particular instructions in the instruction group (i.e., those not having a WAW data dependency on another instruction in the instruction group) that qualify for accelerated RTAG deallocation as disclosed herein. Of course, in other processor architectures, alternative and or additional qualifications for accelerated RTAG deallocation may be imposed on instructions.

At block 906, mapper circuit 300 records in an MHB entry 504 of MHB 500 the evicted and target RTAGs associated with the instructions in the instruction group. At block 908, based on the instruction markings made at block 904, mapper circuit 300 updates GCT 600 with the evicted RTAGs associated with the instructions in the instruction group that have no WAW dependency on another instruction in the instruction group. Mapper circuit 300 additionally blocks MHB 500 from deallocating evicted RTAGs associated with the instructions in the instruction group that have no WAW dependency on another instruction in the instruction group (block 910). Mapper circuit 300 then releases the instruction group for dispatch, by dispatch circuit 216, to execution units 220-226 (block 912). Thereafter, the process of FIG. 9 ends at block 914.

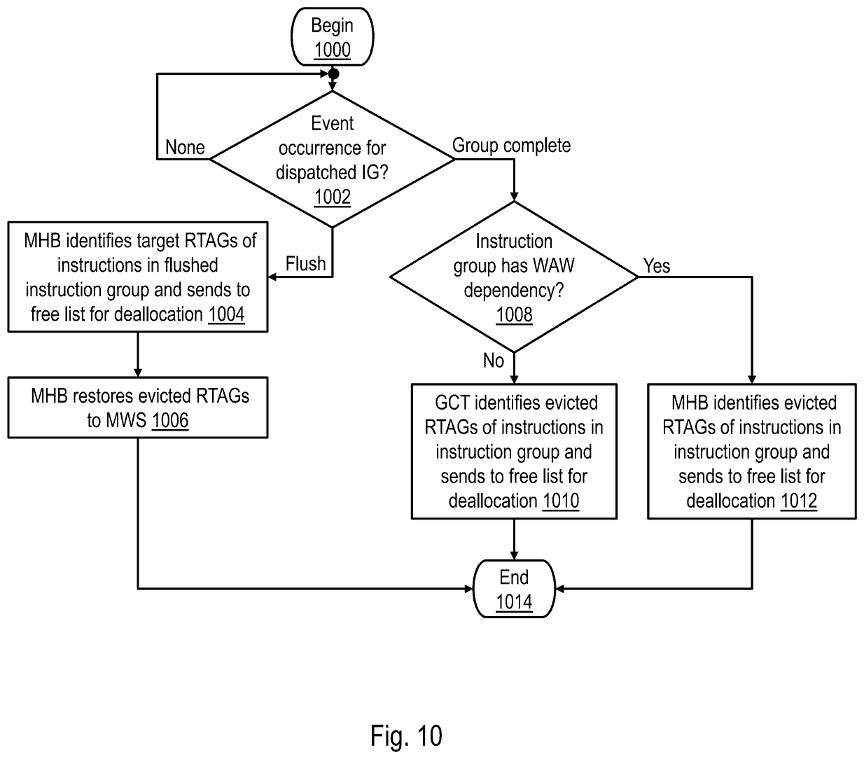

Referring now to FIG. 10, there is depicted a high-level logical diagram of an exemplary process by which a mapper circuit 300 of an exemplary processor core 200 accelerates deallocation of physical registers for instructions of an instructions group not subject to WAW data dependencies in accordance with one embodiment. One or more instances of the process of FIG. 10 can be performed by mapper circuit 300 concurrently with the process of FIG. 9.

The process of FIG. 10 begins at block 1000 and then proceeds to block 1002, which illustrates mapper circuit 300 monitoring for occurrence of an event for an instruction group that has been dispatched for execution. If no event has occurred for a dispatched instruction group, the process continues to iterate at block 1002; if, however, an instruction group flush or an instruction group complete event is detected, the process proceeds from block 1002 to block 1004 or block 1008, respectively.

Block 1004 depicts that, in the event of a flush of a specific dispatched instruction group, MHB 500 identifies within the relevant MHB entry 504 the target RTAGs of the flushed instruction group and transmits the target RTAGs to free list 302 for deallocation, thus making those RTAGs available for allocation to other instructions. In addition, MHB 500 restores, in MWS 304, the mapping of LREGs to the evicted RTAGs read from the relevant MHB entry 504, indicating that the physical registers identified by these RTAGs still hold the valid data associated with the LREGs (block 1006). Following block 1006, the process of FIG. 10 ends at block 1014.

Referring now to block 1008, in the event of a group complete event for a specific dispatched instruction group, mapper circuit 300 determines, based on the markings applied at block 904 whether or not the instruction group has any WAW data dependencies. In response to an affirmative determination at block 1008, the process passes to block 1012, which illustrates MHB 500 performing a lookup in the relevant MHB entry 504 of the evicted RTAGs associated with the instructions in the completing instruction group, for example, in accordance with the process of FIG. 8. MHB 504 transmits these evicted RTAGS to free list 302 for deallocation, thus making those RTAGs available for allocation to other instructions.

If, on the other hand, mapper circuit 300 makes a negative determination at block 1008, MHB 504 remains inhibited from deallocating the evicted RTAGs of the completing instruction group, as discussed above with reference to block 910 of FIG. 9. GCT 600 instead determines, from the relevant GCT entry 602, the evicted RTAGs associated with the instructions in the completing instruction group and transmits these evicted RTAGS to free list 302 for deallocation, thus making those RTAGs available for allocation to other instructions. Those skilled in the art will appreciate that in some alternative embodiments, mapper 300 can deallocate evicted RTAGs of completed instruction groups utilizing either GCT 600 or MHB 500 on an instruction-by-instruction basis rather than for all instructions in the instruction group. Following block 1010 or block 1012, the process of FIG. 10 ends at block 1014. It should be understood, however, that mapper circuit 300 may perform additional processing to finalize completion of the instruction group, including, for example, deallocation from GCT 600 of the GCT entry 602 associated with the completing instruction group.

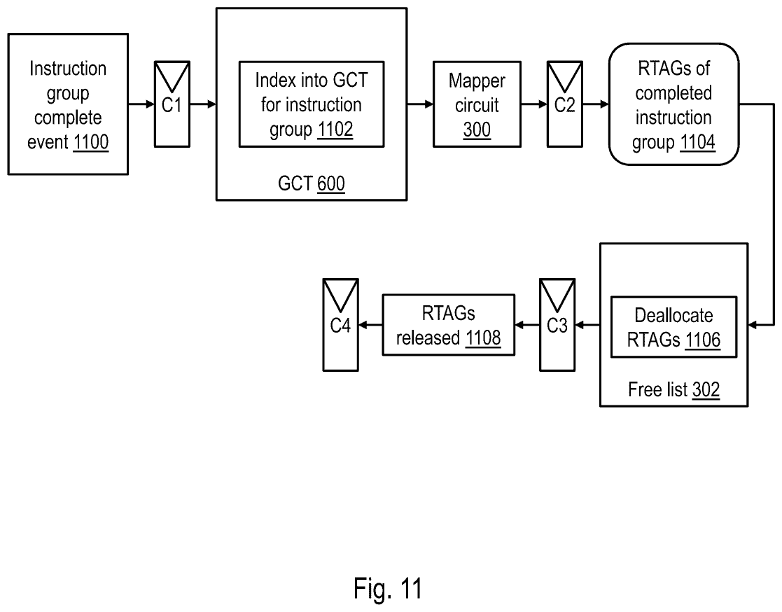

With reference now to FIG. 11, there is illustrated a data flow diagram of an exemplary process for accelerated deallocation of a physical register (RTAG) in a mapper circuit 300 of a processor core 200 in accordance with one embodiment. As in FIG. 8, processor cycles elapsed in the deallocation process are represented by latches distributed in the data flow path, where the names of the illustrated latches designate the number of elapsed cycles (C1, C2, etc.).

In this example, mapper circuit 300 receives an instruction group complete event notification 1100 in cycle 1. The instruction group complete event notification 1100 may specify, for example, a thread ID and an instruction group ID. Based on the contents of instruction group complete event notification 1100, GCT 600 indexes into the GCT entry 602 for the instruction group ID, as depicted at block 1102, and provides the evicted RTAGs of the completing instruction group to mapper circuit 300 in cycle 2. During cycle 3, mapper circuit 300 passes the evicted RTAGs 1104 read from GCT 600 to free list 302 for deallocation as shown at block 1106. The deallocation of the RTAGs in free list 820 releases the deallocated RTAGs for subsequent reallocation in cycle 4, as shown at block 1108. As can be seen by comparison with the prior art data flow given in FIG. 8, use of GCT 600 to buffer the evicted RTAGs of the instruction group significantly accelerates physical register deallocation in cases in which a completing instruction group does not contain any WAW data dependencies.

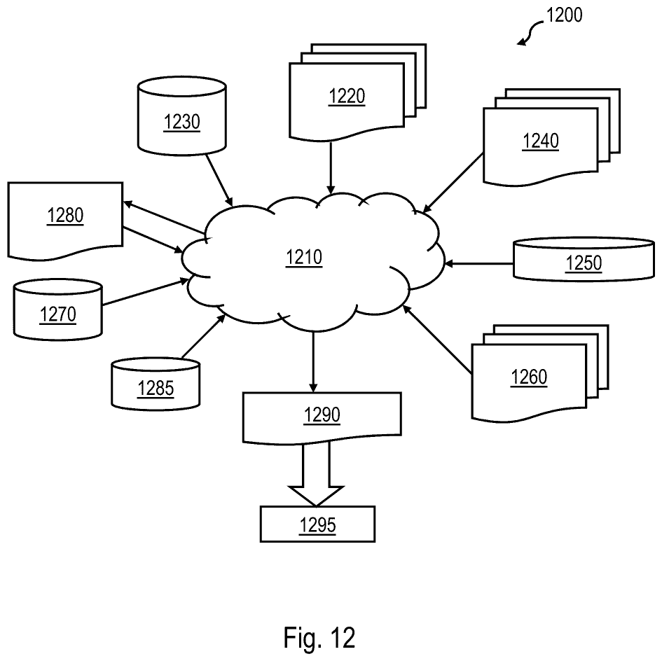

Referring now to FIG. 12, there is illustrated a block diagram of an exemplary design flow 1200 used for example, in semiconductor IC logic design, simulation, test, layout, and manufacture. Design flow 1200 includes processes, machines and/or mechanisms for processing design structures or devices to generate logically or otherwise functionally equivalent representations of the design structures and/or devices described above and shown herein. The design structures processed and/or generated by design flow 1200 may be encoded on machine-readable transmission or storage media to include data and/or instructions that when executed or otherwise processed on a data processing system generate a logically, structurally, mechanically, or otherwise functionally equivalent representation of hardware components, circuits, devices, or systems. Machines include, but are not limited to, any machine used in an IC design process, such as designing, manufacturing, or simulating a circuit, component, device, or system. For example, machines may include: lithography machines, machines and/or equipment for generating masks (e.g. e-beam writers), computers or equipment for simulating design structures, any apparatus used in the manufacturing or test process, or any machines for programming functionally equivalent representations of the design structures into any medium (e.g. a machine for programming a programmable gate array).

Design flow 1200 may vary depending on the type of representation being designed. For example, a design flow 1200 for building an application specific IC (ASIC) may differ from a design flow 1200 for designing a standard component or from a design flow 1200 for instantiating the design into a programmable array, for example a programmable gate array (PGA) or a field programmable gate array (FPGA) offered by Altera® Inc. or Xilinx® Inc.

FIG. 12 illustrates multiple such design structures including an input design structure 1020 that is preferably processed by a design process 1210. Design structure 1220 may be a logical simulation design structure generated and processed by design process 1210 to produce a logically equivalent functional representation of a hardware device. Design structure 1220 may also or alternatively comprise data and/or program instructions that when processed by design process 1210, generate a functional representation of the physical structure of a hardware device. Whether representing functional and/or structural design features, design structure 1220 may be generated using electronic computer-aided design (ECAD) such as implemented by a core developer/designer. When encoded on a machine-readable data transmission, gate array, or storage medium, design structure 1220 may be accessed and processed by one or more hardware and/or software modules within design process 1210 to simulate or otherwise functionally represent an electronic component, circuit, electronic or logic module, apparatus, device, or system such as those shown herein. As such, design structure 1220 may comprise files or other data structures including human and/or machine-readable source code, compiled structures, and computer-executable code structures that when processed by a design or simulation data processing system, functionally simulate or otherwise represent circuits or other levels of hardware logic design. Such data structures may include hardware-description language (HDL) design entities or other data structures conforming to and/or compatible with lower-level HDL design languages such as Verilog and VHDL, and/or higher-level design languages such as C or C++.

Design process 1210 preferably employs and incorporates hardware and/or software modules for synthesizing, translating, or otherwise processing a design/simulation functional equivalent of the components, circuits, devices, or logic structures shown herein to generate a netlist 1280 which may contain design structures such as design structure 1220. Netlist 1280 may comprise, for example, compiled or otherwise processed data structures representing a list of wires, discrete components, logic gates, control circuits, I/O devices, models, etc. that describes the connections to other elements and circuits in an integrated circuit design. Netlist 1280 may be synthesized using an iterative process in which netlist 1280 is resynthesized one or more times depending on design specifications and parameters for the device. As with other design structure types described herein, netlist 1280 may be recorded on a machine-readable storage medium or programmed into a programmable gate array. The medium may be a non-volatile storage medium such as a magnetic or optical disk drive, a programmable gate array, a compact flash, or other flash memory. Additionally, or in the alternative, the medium may be a system or cache memory, or buffer space.

Design process 1210 may include hardware and software modules for processing a variety of input data structure types including netlist 1280. Such data structure types may reside, for example, within library elements 1230 and include a set of commonly used elements, circuits, and devices, including models, layouts, and symbolic representations, for a given manufacturing technology (e.g., different technology nodes, 32 nm, 45 nm, 120 nm, etc.). The data structure types may further include design specifications 1240, characterization data 1250, verification data 1260, design rules 1290, and test data files 1285 which may include input test patterns, output test results, and other testing information. Design process 1210 may further include, for example, standard mechanical design processes such as stress analysis, thermal analysis, mechanical event simulation, process simulation for operations such as casting, molding, and die press forming, etc. One of ordinary skill in the art of mechanical design can appreciate the extent of possible mechanical design tools and applications used in design process 1210 without deviating from the scope and spirit of the invention. Design process 1210 may also include modules for performing standard circuit design processes such as timing analysis, verification, design rule checking, place and route operations, etc.

Design process 1210 employs and incorporates logic and physical design tools such as HDL compilers and simulation model build tools to process design structure 1220 together with some or all of the depicted supporting data structures along with any additional mechanical design or data (if applicable), to generate a second design structure 1290. Design structure 1290 resides on a storage medium or programmable gate array in a data format used for the exchange of data of mechanical devices and structures (e.g., information stored in a IGES, DXF, Parasolid XT, JT, DRG, or any other suitable format for storing or rendering such mechanical design structures). Similar to design structure 1220, design structure 1290 preferably comprises one or more files, data structures, or other computer-encoded data or instructions that reside on transmission or data storage media and that when processed by an ECAD system generate a logically or otherwise functionally equivalent form of one or more of the embodiments of the invention shown herein. In one embodiment, design structure 1290 may comprise a compiled, executable HDL simulation model that functionally simulates the devices shown herein.

Design structure 1290 may also employ a data format used for the exchange of layout data of integrated circuits and/or symbolic data format (e.g., information stored in a GDSII (GDS2), GL1, OASIS, map files, or any other suitable format for storing such design data structures). Design structure 1290 may comprise information such as, for example, symbolic data, map files, test data files, design content files, manufacturing data, layout parameters, wires, levels of metal, vias, shapes, data for routing through the manufacturing line, and any other data required by a manufacturer or other designer/developer to produce a device or structure as described above and shown herein. Design structure 1290 may then proceed to a stage 1295 where, for example, design structure 1290: proceeds to tape-out, is released to manufacturing, is released to a mask house, is sent to another design house, is sent back to the customer, etc.

As has been described, a processor includes a mapper circuit that, based on receiving an instruction group of multiple instructions for dispatch, establishes, in a first mapper structure, mappings of logical registers targeted by the multiple instructions to physical registers in the processor. The mapper circuit maintains, in a second mapper structure, prior mappings for the logical registers. The mapper circuit records, in a third mapper structure, physical registers previously allocated to the logical registers targeted by the instructions, where the third mapper structure has a lower access latency than the second mapper structure. Based on a flush event for the instruction group, the mapper circuit restores the prior mappings from the second mapper structure to the first mapper structure. Based on a complete event for the instruction group, the mapper circuit deallocates the physical registers previously allocated to the logical registers targeted by the instructions by reference to the third mapper structure rather than the second mapper structure.

While various embodiments have been particularly shown and described, it will be understood by those skilled in the art that various changes in form and detail may be made therein without departing from the spirit and scope of the appended claims and these alternate implementations all fall within the scope of the appended claims.

Aspects of the present invention are described herein with reference to flowchart illustrations and/or block diagrams that illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Further, although aspects have been described with respect to a computer system executing program code that directs the functions of the present invention, it should be understood that present invention may alternatively be implemented as a program product including a computer-readable storage device storing program code that can be processed by a data processing system. The computer-readable storage device can include volatile or non-volatile memory, an optical or magnetic disk, or the like. However, as employed herein, a “storage device” is specifically defined to include only statutory articles of manufacture and to exclude signal media per se, transitory propagating signals per se, and energy per se.

The program product may include data and/or instructions that when executed or otherwise processed on a data processing system generate a logically, structurally, or otherwise functionally equivalent representation (including a simulation model) of hardware components, circuits, devices, or systems disclosed herein. Such data and/or instructions may include hardware-description language (HDL) design entities or other data structures conforming to and/or compatible with lower-level HDL design languages such as Verilog and VHDL, and/or higher-level design languages such as C or C++. Furthermore, the data and/or instructions may also employ a data format used for the exchange of layout data of integrated circuits and/or symbolic data format (e.g., information stored in a GDSII (GDS2), GL1, OASIS, map files, or any other suitable format for storing such design data structures).

The figures described above and the written description of specific structures and functions are not presented to limit the scope of what Applicants have invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms and that multiple of the disclosed embodiments can be combined. Lastly, the use of a singular term, such as, but not limited to, “a” is not intended as limiting of the number of items.

What is claimed is:

1. A method of data processing in a data processing system including a processor, the method comprising:
a mapper circuit, based on receiving an instruction group of multiple instructions for dispatch, establishing, in a first mapper structure, mappings of logical registers targeted by the multiple instructions to physical registers in the processor;
the mapper circuit maintaining, in a second mapper structure, prior mappings for the logical registers;
the mapper circuit recording, in a third mapper structure, physical registers previously allocated to the logical registers targeted by the instructions, the third mapper structure having a lower access latency than the second mapper structure;
based on a flush event for the instruction group, the mapper circuit restoring the prior mappings from the second mapper structure to the first mapper structure; and
based on a complete event for the instruction group, the mapper circuit deallocating the physical registers previously allocated to the logical registers targeted by the instructions by reference to the third mapper structure rather than the second mapper structure.

2. The method of claim 1, wherein recording the physical registers previously allocated to the logical registers targeted by the instructions includes recording, with a completion structure, the physical registers previously allocated to the logical registers targeted by the instructions.

3. The method of claim 1, wherein the first mapper structure is a working set mapper and the second mapper structure is a partitioned mapper history buffer.

4. The method of claim 1, wherein the deallocating comprises deallocating the physical registers by reference to the third mapper structure only based on the instructions not having a mutual write-after-write data dependency.

5. The method of claim 1, wherein:
the third mapper structure is a completion structure; and
the deallocating includes indexing into the completion structure utilizing an instruction group identifier assigned to the instruction group.

6. The method of claim 1, wherein the deallocating includes updating status of the physical registers in a free list structure.

7. A processor comprising:
a cache memory;
a processor core coupled to the cache memory, the processor core including:
physical registers for buffering operands of instructions;
at least one execution unit configured to execute instructions to produce operands, wherein the instructions target logical registers;
a mapper circuit having first, second, and third mapper structures, wherein the third mapper structure has a lower access latency than the second mapper structure, and wherein the mapper circuit is configured to perform:
based on receiving an instruction group of multiple instructions for dispatch, establishing, in the first mapper structure, mappings of logical registers targeted by the multiple instructions to physical registers;
maintaining, in the second mapper structure, prior mappings for the logical registers;
recording, in the third mapper structure, physical registers previously allocated to the logical registers targeted by the instructions;
based on a flush event for the instruction group, the mapper circuit restoring the prior mappings from the second mapper structure to the first mapper structure; and
based on a complete event for the instruction group, the mapper circuit deallocating the physical registers previously allocated to the logical registers targeted by the instructions by reference to the third mapper structure rather than the second mapper structure.

8. The processor of claim 7, wherein the third mapper structure is a completion structure.

9. The processor of claim 7, wherein the first mapper structure is a working set mapper and the second mapper structure is a partitioned mapper history buffer.

10. The processor of claim 7, wherein the mapper circuit is configured to deallocate the physical registers by reference to the third mapper structure only based on the instructions not having a mutual write-after-write data dependency.

11. The processor of claim 7, wherein:
the third mapper structure is a completion structure; and
the deallocating includes the mapper structure indexing into the completion structure utilizing an instruction group identifier assigned to the instruction group.

12. The processor of claim 7, wherein:
the mapper structure has a free list structure; and
the deallocating includes the mapper circuit updating status of the physical registers in the free list structure.

13. A design structure tangibly embodied in a machine-readable storage device for designing, manufacturing, or testing an integrated circuit, the design structure comprising:
a processor including:
a cache memory;
a processor core coupled to the cache memory, the processor core including:
physical registers for buffering operands of instructions;
at least one execution unit configured to execute instructions to produce operands, wherein the instructions target logical registers;
a mapper circuit having first, second, and third mapper structures, wherein the third mapper structure has a lower access latency than the second mapper structure, and wherein the mapper circuit is configured to perform:
based on receiving an instruction group of multiple instructions for dispatch, establishing, in the first mapper structure, mappings of logical registers targeted by the multiple instructions to physical registers;
maintaining, in the second mapper structure, prior mappings for the logical registers;
recording, in the third mapper structure, physical registers previously allocated to the logical registers targeted by the instructions;
based on a flush event for the instruction group, the mapper circuit restoring the prior mappings from the second mapper structure to the first mapper structure; and
based on a complete event for the instruction group, the mapper circuit deallocating the physical registers previously allocated to the logical registers targeted by the instructions by reference to the third mapper structure rather than the second mapper structure.

14. The design structure of claim 13, wherein the third mapper structure is a completion structure.

15. The design structure of claim 13, wherein the first mapper structure is a working set mapper and the second mapper structure is a partitioned mapper history buffer.

16. The design structure of claim 13, wherein the mapper circuit is configured to deallocate the physical registers by reference to the third mapper structure only based on the instructions not having a mutual write-after-write data dependency.

17. The design structure of claim 13, wherein:
the third mapper structure is a completion structure; and
the deallocating includes the mapper structure indexing into the completion structure utilizing an instruction group identifier assigned to the instruction group.

18. The design structure of claim 13, wherein:
the mapper structure has a free list structure; and
the deallocating includes the mapper circuit updating status of the physical registers in the free list structure.
